(19) United States
(12) Patent Application Publication
(10) Pub. No.: US 2025/0168622 A1
(43) Pub. Date: May 22, 2025

(54) IMS APN REDIRECT FOR ROAMING WIRELESS DEVICE

(71) Applicant: T-Mobile Innovations LLC, Overland Park, KS (US)

(72) Inventors: Joel ARENDS, Renton, WA (US); Kunal BARAWKAR, Bothell, WA (US); Nassereddine SABEUR, Bellevue, WA (US)

(21) Appl. No.: 18/514,021

(22) Filed: Nov. 20, 2023

(51) Int. Cl. H04W 8/26; H04W 8/08; H04W 80/10

(52) U.S. Cl. CPC H04W 8/26; H04W 8/08; H04W 80/10

(57) ABSTRACT

Systems, methods, and devices are provided for adjusting the IMS APN/P-GW for a roaming wireless device. Methods include receiving an attach request for data services from a roaming wireless device at an IMS APN/P-GW of a visited network. Methods further include obtaining the home IMS APN/P-GW for the home network for the roaming wireless device and adjusting the IMS APN/P-GW for the roaming mobile to the IMS APN/P-GW of the visited network.

### TECHNICAL BACKGROUND

A wireless network, such as a cellular network, can include an access node (e.g., base station) serving multiple wireless devices or user equipment (UE) in a geographical area covered by a radio frequency transmission provided by the access node. Access nodes may deploy different carriers within the cellular network utilizing different types of radio access technologies (RATs). RATs can include, for example, 3G RATs (e.g., GSM, CDMA etc.), 4G RATs (e.g., WiMax, long term evolution (LTE), etc.), and 5G RATs (new radio (NR)). Further, different types of access nodes may be implemented for deployment for the various RATs. For example, an evolved NodeB (eNodeB or eNB) may be utilized for 4G RATs and a next generation NodeB (gNodeB or gNB) may be utilized for 5G RATs.

In current 4G and 5G implementations, users may utilize wireless devices or UEs based on subscriptions. Wireless devices or UEs based on subscriptions may also have access to visiting networks when roaming outside of a home network.

### OVERVIEW

One aspect of the present disclosure relates to a system configured for adjusting an IMS APN for a wireless device. The system may include one or more hardware processors configured by machine-readable instructions. The processor(s) may be configured to receive an inbound roaming communication from a wireless device to access a first IP multimedia core network subsystem access point name. The processor(s) may be configured to transmit an update-location-request for the wireless device to home subscriber server. The processor(s) may be configured to receive an update-location-answer for the wireless device. The processor(s) may be configured to, in response to ULA for the wireless device, adjust an IMS APN for the wireless device to the first IMS APN for wireless device.

In some implementations of the system, the ULA may identify a second IMS APN for the wireless device.

In some implementations of the system, adjusting an IMS APN may be modifying the second IMS APN to the first IMS APN for the wireless device.

In some implementations of the system, adjusting an IMS APN may be adding the first IMS APN for the wireless device.

In some implementations of the system, the response to the ULA may do not identify an IMS APN for the wireless device.

In some implementations of the system, adjusting the IMS APN may be adding the first IMS APN for the wireless device.

In some implementations of the system, the first IMS APN may be for a first mobile network operator.

Another aspect of the present disclosure relates to a method for adjusting an IMS APN for a wireless device. The method may include receiving an inbound roaming communication from a wireless device to access a first IP multimedia core network subsystem access point name. The method may include transmitting an update-location-request for the wireless device to home subscriber server. The method may include receiving an update-location-answer for the wireless device. The method may include, in response to ULA for the wireless device, adjusting an IMS APN for the wireless device to the first IMS APN for wireless device.

Yet another aspect of the present disclosure relates to a non-transient computer-readable storage medium having instructions embodied thereon, the instructions being executable by one or more processors to perform a method for adjusting an IMS APN for a wireless device. The method may include receiving an inbound roaming communication from a wireless device to access a first IP multimedia core network subsystem access point name. The method may include transmitting an update-location-request for the wireless device to home subscriber server. The method may include receiving an update-location-answer for the wireless device. The method may include, in response to ULA for the wireless device, adjusting an IMS APN for the wireless device to the first IMS APN for wireless device.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

FIG. 1 depicts an exemplary operating environment system for adjusting IMS APN for roaming wireless devices in accordance with the disclosed embodiments.

FIG. 2 illustrates an additional exemplary operating environment for an IMS APN adjustment system in accordance with disclosed embodiments.

FIG. 3 illustrates an embodiment of an IMS APN adjustment system in accordance with disclosed embodiments.

FIG. 4 is a flowchart depicting initial processing of attach request for a roaming wireless device in accordance with disclosed embodiments.

FIG. 5 is a flowchart depicting additional method steps roaming wireless device attachment in accordance with the disclosed embodiments.

FIG. 6 is a flowchart illustrating adjusting the IMS/APN for a roaming wireless device in accordance with disclosed embodiments.

### DETAILED DESCRIPTION

Exemplary embodiments described herein include systems, methods, and devices for adjusting IMS APNs for roaming wireless devices. Embodiments provided herein modify existing network processes and components to support redirecting inbound roaming wireless devices to a visited P-GW/IMS network for data services.

Typically, if a wireless subscriber travels to another region/country outside of the coverage of the subscriber mobile network operator (MNO) the wireless subscriber manually adjusts the IMS APN on the subscriber wireless device to the correct IMS APN for the travel destination region/country. However, if the subscriber does not change or enters the incorrect IMS APN settings, the roaming wireless device will not be able to use the internet through the data network in the travel destination region/country.

In examples, a method and system for an MME of a mobile network operator (MNO) to redirect inbound roamers to a visited PGW/IMS network is provided. The PGW acts as the interface between the cellular network and other packet data networks, such as the Internet or SIP-based IMS networks. The MME of a visited network will be able modify or add an IMS APN for the inbound roamer and redirect the roaming wireless device to the visited P-GW without the subscriber manually adjusting the IMS APN on the subscriber wireless device.

Inbound roaming communication from a wireless device to access a first IP Multimedia Core Network Subsystem (IMS) access point name (APN) is received at a visited network. The MME of the visited network transmits Update-Location-Request (ULR) for the wireless device to Home Subscriber Server (HSS) of the home network for the wireless device. The HSS of the home network transmits an Update-Location-Answer (ULA) for the wireless device to the MME of the visited network. The ULA may include a home network IMS APN and/or MCCMNC. In response to receiving ULA for the wireless device, the IMS APN for the wireless device is adjusted to the first IMS APN of the visited network for wireless device. The wireless device will then be able to access data services through the first IMS APN of the visited network.

Once the IMS APN has been adjusted to the visited IMS APN for the visited network, if the wireless device returns to the home network and subsequently attempts to reattach the visited network, the MME will remember the wireless device and have established the visited IMS APN so that the wireless device can access data services on the visited network.

In some instances, adjusting an IMS APN for the visiting wireless device may be modifying the home network IMS APN to the visited network IMS APN for the wireless device may include changing the IMS APN from the home network IMS APN to the visited network IMS APN. In other instances, adjusting an IMS APN for the visiting wireless device may be adding the visited network IMS APN for the wireless device. The visited IMS APN routes to a first P-GW and the second IMS APN routes to a second and different P-GW.

In some instances, the visited network is for a first mobile network operator (MNO) and the home network is a second and separate MNO. The visited IMS APN and the home IMS APN may be for different countries.

In some examples, adjusting the IMS APN for the first IMS APN for the wireless device comprises adjusting an IMS APN table at a Mobility Management Entity (MME) for a first MNO. The IMS APN table at the MME is a S8HR or a non-S8HR table.

In embodiments set forth herein, a distributed system may be provided that operates within the evolved packet core (EPC) and the IMS. Alternatively, an initial attachment prioritization system may be a discrete system providing instructions to components of the EPC or IMS.

Through the use of systems, methods, and devices described herein, providing data services to roaming wireless devices are improved by adjusting the IMS APN for the mobile service at the MNO.

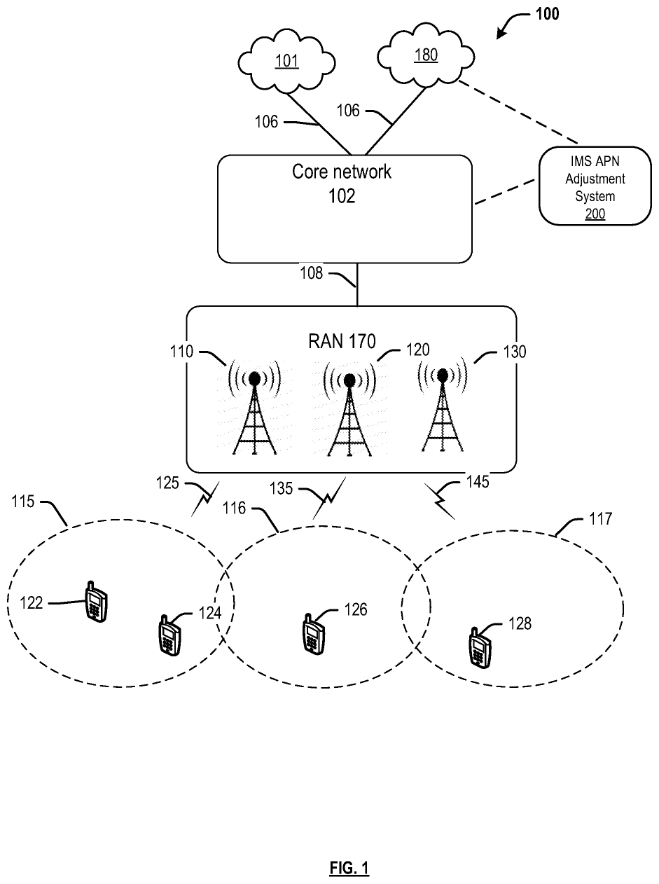

FIG. 1 depicts an exemplary system 100 for wireless communication, in accordance with the disclosed embodiments. The system 100 may include a communication network 101, IMS 180, core network 102, and a radio access network (RAN) 170 including access nodes 110, 120, and 130. The RAN 170 may include other devices and additional access nodes. Although three access nodes are shown, any number of access nodes may be included.

The system 100 also includes multiple wireless devices 122, 124, 126, and 128, which may be end-user wireless devices and may operate within one or more coverage areas 115, 116, and 117. The wireless devices 122, 124, 126, 128 communicate with access nodes 110, 120, and/or 130 within the RAN 170 over communication links 125, 135, and 145.

The system 100 may further include an IMS APN adjustment system 200, which is illustrated as operating between the core network 102 and the IMS system 180. However, it should be noted that the IMS APN adjustment system 200 may be distributed. For example, the IMS APN adjustment system 200 may utilize components located at both the core network 102 and the IMS 180. Alternatively, the IMS APN adjustment system 200 may be an entirely discrete system operating within the core 102, within the IMS 180, or between the core network 102 and the IMS 180.

The IMS APN adjustment system 200 operates based on requests for attachment from the roaming wireless devices 122, 124, 126, and 128. The attach requests may reach the core network 102 or the IMS 180 depending on the services being requested. The components of the core network 102 or the IMS 180 transmit the request to the IMS APN adjustment system 200 to authenticate and determine IMS APN for the roaming wireless device. Based on the look-up, the IMS APN adjustment system 200 transmits a response including an adjusted IMS APN for the roaming wireless device.

The IMS 180 is a standards-based architectural framework for delivering multimedia communications services such as voice, video, and text messaging over IP networks. The IMS 180 enables secure and reliable multimedia communications between diverse devices across diverse networks. The architectural model provides a unified infrastructure and common mechanisms for controlling, manipulating, routing, and managing sessions. A control layer of the IMS 180, often referred to as the IMS core, is responsible for regulating communications flows.

Communication network 101 can be a wired and/or wireless communication network, and can comprise processing nodes, routers, gateways, and physical and/or wireless data links for carrying data among various network elements, including combinations thereof, and can include a local area network a wide area network, and an internetwork (including the Internet). Communication network 101 can be capable of carrying data, for example, to support voice, push-to-talk, broadcast video, and data communications by wireless devices 122, 124, 126, 128. Wireless network protocols can comprise Multimedia Broadcast Multicast Services (MBMS), code division multiple access (CDMA) 1×RTT, Global System for Mobile communications (GSM), Universal Mobile Telecommunications System (UMTS), High-Speed Packet Access (HSPA), Evolution Data Optimized (EV-DO), EV-DO rev. A, Third Generation Partnership Project Long Term Evolution (3GPP LTE), Worldwide Interoperability for Microwave Access (WiMAX), Fourth Generation broadband cellular (4G, LTE Advanced, etc.), and Fifth Generation mobile networks or wireless systems (5G, 5G New Radio (“5G NR”), or 5G LTE). Wired network protocols that may be utilized by communication network 101 comprise Ethernet, Fast Ethernet, Gigabit Ethernet, Local Talk (such as Carrier Sense Multiple Access with Collision Avoidance), Token Ring, Fiber Distributed Data Interface (FDDI), and Asynchronous Transfer Mode (ATM). Communication network 101 can also comprise additional base stations, controller nodes, telephony switches, internet routers, network gateways, computer systems, communication links, or some other type of communication equipment, and combinations thereof.

The core network 102 includes core network functions and elements. The core network 102 may have an evolved packet core (EPC) structure. The network functions and elements may be separated into user plane functions and control plane functions. The user plane accesses a data network, such as network 101, and performs operations such as packet routing and forwarding, packet inspection, policy enforcement for the user plane, quality of service (QOS) handling, etc. The control plane handles radio-specific functionality that depends on the idle or connected states of the wireless devices 122, 124, 126, and 128.

Communication links 106 and 108 can use various communication media, such as air, space, metal, optical fiber, or some other signal propagation path-including combinations thereof. Communication links 106 and 108 can be wired or wireless and use various communication protocols such as Internet, Internet protocol (IP), local-area network (LAN), S1, optical networking, hybrid fiber coax (HFC), telephony, T1, or some other communication format-including combinations, improvements, or variations thereof. Wireless communication links may use electromagnetic waves in the radio frequency (RF), microwave, infrared (IR), or other wavelength ranges, and may use a suitable communication protocol, including but not limited to Global System for Mobile telecommunications (GSM), Code Division Multiple Access (CDMA), Worldwide Interoperability for Microwave Access (WiMAX), Multimedia Broadcast Multicast Service (MBMS), Single-Carrier Radio Transmission Technology (1×RTT), Universal Mobile Telecommunications System (UMTS), High Speed Packet Access (HSPA), Evolution-Data Optimized (EV-DO), EV-DO rev. A, 3GPP LTE, WiMAX, 4G including LTE Advanced and the like, and 5G including 5G NR or 5G Advanced, 6G, NTN, or combinations thereof.

Communication links 106 and 108 can be direct links or might include various equipment, intermediate components, systems, and networks, such as a cell site router, etc. Communication links 106 and 108 may comprise many different signals sharing the same link.

The RAN 170 may include various access network systems and devices such as access nodes 110, 120, 130. The RAN 170 is disposed between the core network 102 and the end-user wireless devices 122, 124, 126, 128. Components of the RAN 170 may communicate directly with the core network 102 and/or the IMS 180 and others may communicate directly with the end user wireless devices 122, 124, 126, 128. The RAN 170 may provide services from the core network 102 to the end-user wireless devices 122, 124, 126, and 128.

The RAN 170 includes multiple access nodes (or base stations) 110, 120, 130, which may include one or more eNodeBs and additionally might include a next generation NodeB (gNodeB) communicating with the plurality of end-user wireless devices 122, 124, 126, 128. It is understood that the disclosed technology for may also be applied to communication between an end-user wireless device and other network resources, such as relay nodes, controller nodes, antennas, etc. Further, multiple access nodes may be utilized. For example, some wireless devices may communicate with an LTE eNodeB, and others may communicate with an NR gNodeB. The RAN 170 may further comprise a non-terrestrial network (NTN) serving the multiple UEs by a radio frequency transmission provided by utilizing orbiting satellites that may be in communication with access nodes of a terrestrial network TN. The satellites may include geosynchronous equatorial orbit (GEO) satellites, Medium Earth Orbit (MEO) satellites, and low Earth orbit (LEO) satellites. The NTN may include NTN nodes that are not stationed on the ground.

Access nodes 110, 120, 130 can be, for example, standard access nodes such as a macro-cell access node, a base transceiver station, a radio base station, an eNodeB device, an enhanced eNodeB device, a next generation NodeB (or gNodeB) in 5G New Radio (“5G NR”), or the like. In additional embodiments, access nodes may comprise two co-located cells, or antenna/transceiver combinations that are mounted on the same structure. Alternatively, access nodes 110, 120, 130 may comprise a short range, low power, small-cell access node such as a microcell access node, a picocell access node, a femtocell access node, or a home eNodeB device. Access nodes 110, 120, 130 can be configured to deploy one or more different carriers, utilizing one or more RATs. For example, a gNodeB may support NR and an eNodeB may provide LTE coverage. Any other combination of access nodes and carriers deployed therefrom may be evident to those having ordinary skill in the art in light of this disclosure.

The access nodes 110, 120, 130 can comprise a processor and associated circuitry to execute or direct the execution of computer-readable instructions. Access nodes can retrieve and execute software from storage, which can include a disk drive, a flash drive, memory circuitry, or some other memory device, and which can be local or remotely accessible. The software comprises computer programs, firmware, or some other form of machine-readable instructions, and may include an operating system, utilities, drivers, network interfaces, applications, or some other type of software, including combinations thereof.

The wireless devices 122, 124, 126, and 128 may include any wireless device included in a wireless network. For example, the term “wireless device” may include a relay node, which may communicate with an access node. The term “wireless device” may also include an end-user wireless device, which may communicate with the access node in the access network 110 through the relay node. The term “wireless device” may further include an end-user wireless device that communicates with the access node directly without being relayed by a relay node. Wireless devices 122, 124, 126, and 128 may be any device, system, combination of devices, or other such communication platform capable of communicating wirelessly with access network 110 using one or more frequency bands and wireless carriers deployed therefrom. Each of wireless devices 122, 124, 126, and 128, may be, for example, a mobile device, a mobile phone, a wireless phone, a wireless modem, a personal digital assistant (PDA), a voice over internet protocol (VOIP) phone, a voice over packet (VOP) phone, or a soft phone, a wearable device, an internet of things (IoT) device, as well as other types of devices or systems that can send and receive audio or data. The wireless devices 122, 124, 126 128 may be or include high power wireless devices or standard power wireless devices.

System 100 may further include many components not specifically shown in FIG. 1 including processing nodes, controller nodes, routers, gateways, and physical and/or wireless data links for communicating signals among various network elements. System 100 may include one or more of a local area network, a wide area network, and an internetwork (including the Internet). Communication system 100 may be capable of communicating signals and carrying data, for example, to support voice, push-to-talk, broadcast video, and data communications by end-user wireless devices 122, 124, 126, and 128.

Other network elements may be present in system 100 to facilitate communication but are omitted for clarity, such as base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements, e.g., between the radio access network 170 and the core network 102.

The methods, systems, devices, networks, access nodes, and equipment described herein may be implemented with, contain, or be executed by one or more computer systems and/or processing nodes. The methods described above may also be stored on a non-transitory computer readable medium. Many of the elements of communication system 100 may be, comprise, or include computers systems and/or processing nodes, including access nodes, controller nodes, and gateway nodes described herein.

The IMS APN adjustments may be implemented as computer-readable instructions or methods, and processing nodes on the network for executing the instructions or methods. The processing node may include a processor included in the access node or a processor included in any controller node in the wireless network that is coupled to the access node.

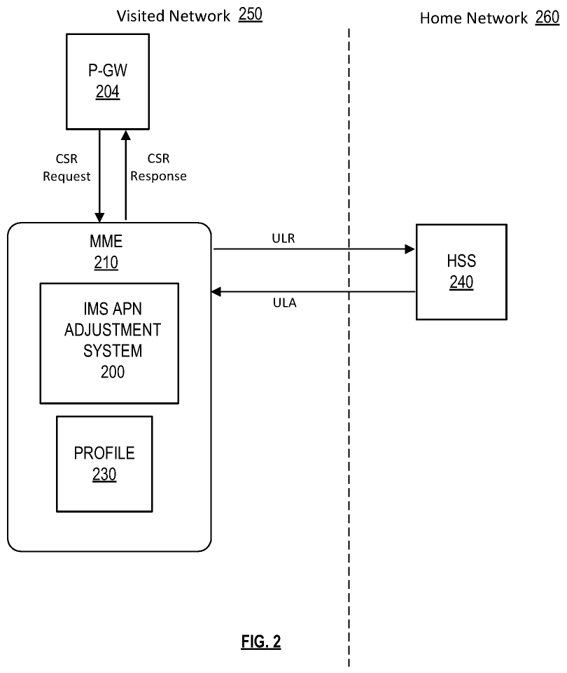

FIG. 2 depicts an exemplary environment for an IMS APN adjustment system 200 in accordance with the disclosed embodiments. As explained above, the IMS APN adjustment system 200 may be a discrete component or may be incorporated in a core network 102 or IMS 180 or distributed across the core network 102 and IMS 180. The environment shown in FIG. 2 illustrates operation of the IMS APN adjustment system 200 with reference to both components of the core network 102 and the IMS 180. Components shown in FIG. 2 include a packet gateway (P-GW) 204, a mobility management entity (MME) 210, one or more home subscriber servers (HSS) 240. The connected components further include an IMS APN profile 230.

When a roaming wireless device 122, 124, 126, 128 sends an initial attach request, a session request is forwarded to the P-GW 204. The P-GW 204 provides interfaces toward the IMS 180 and network 101. The P-GW 204 sends a customer service record (CSR) request to MME 210 to authenticate a wireless device prior to providing data services. The CSR is a request to authenticate a wireless device, such as roaming wireless device 122, 124, 126, 128.

Roaming occurs when a wireless device 122, 124, 126, 128 is used outside the range of its home network 250 and tries to connect to another available cell network, such as visited network 260. Roaming refers to the ability for a cellular customer to automatically make and receive voice calls, send, and receive data, or access other services, including data services, when travelling outside the geographical coverage area of the home network 250, by using a visited network 260.

The legal roaming agreements are negotiated between the roaming partners, such as MNOs, for authentication, authorization, and billing of the visiting wireless device 122, 124, 126, 128. For data services, when wireless device 122, 124, 126, 128 is turned on or is transferred via a handover to a network, wireless device 122, 124, 126, 128 attempts to attached to the P-GW 204 of visited network 260 for data services. The P-GW 204 of visited network 260 sends a customer service record (CSR) request to MME 210 to authenticate wireless device 122, 124, 126, 128. MME determines wireless device 122, 124, 126, 128 is not registered (e.g., not subscribers) with visited network 260. MME 210 sends an Update-Location-Request (ULR) to home subscriber server (HSS) 240 of the home network 250 for wireless device 122, 124, 126, 128. HSS 240 of home network 250 returns an Update-Location-Answer (ULA).

If there is no roaming agreement between visited network 260 and home network 250, data services may be denied to wireless device 122, 124, 126, 128 by the visited network 260. If there is a roaming agreement between visited network 260 and home network 250, data services may be provided to wireless device 122, 124, 126, 128 by the visited network 260.

If successful, visited network 260 begins to maintain a temporary subscriber record for the device. Likewise, the home network 250 updates its information to indicate that the wireless device 122, 124, 126, 128 is on the visited network 260 so that any information sent to that device can be correctly routed.

In one example, the ULA returned by home network 250 includes an IMS APN which is set to route back to a home P-GW of home network 250. The ULA may include the mobile country codes and mobile network codes (MCCMNC) value for the home network 250 of wireless device 122, 124, 126, 128. MME 210 adjusts an IMS APN profile 230 for wireless device 122, 124, 126, 128 to route wireless device 122, 124, 126, 128 to visited P-GW 204 of visited network 260 rather than the P-GW of home network 250. In an example, a non-S8HR table in IMS APN profile 230 may add or modify the IMS APN for wireless device 122, 124, 126, 129. An S8HR table in IMS APN profile 230 may add the IMS APN.

In another example, the ULA returned by home network 250 does not include an IMS APN for home network 250. The ULA, in this example, may not include the mobile country codes and mobile network codes (MCCMNC) value for the home network 250 of wireless device 122, 124, 126, 128. MME 210 adjusts an IMS APN profile 230 by adding the visited P-GW 204 to route wireless device 122, 124, 126, 128 to visited P-GW 204 of visited network 260. In an example, a non-S8HR table in IMS APN profile 230 may add or modify the IMS APN for wireless device 122, 124, 126, 129. An S8 home routing (S8HR) table in IMS APN profile 230 may add the IMS APN.

The MME 210 is responsible for authenticating the wireless devices 122, 124, 126, 128. Further, the MME 210 has the capability to select a P-GW for serving each wireless device 122, 124, 126. The MME 210 controls data sessions by setting up and terminating the data sessions. In order to reach the IMS APN adjustment system 200 and the connected components described above, the attach request transmitted from a wireless device 122, 124, 126, 128 and reaches the MME 210 in the core network 102.

The HSS 240 is shown as one component. However, multiple HSS 240 may be included in both the IMS 180 and the core network 102. The HSS 240 includes a database of subscriber and service data and contains subscription-related information (user profiles). The HSS 240 is used for registration and authentication in both the core network 102 and the IMS 180. The HSS 240 thus can be utilized to determine which services a user can access, and users can be assigned to an HSS 240 based on their identities.

In operation, components of the IMS APN adjustment system 200 may interact with the illustrated components and may be incorporated in the illustrated components. This interaction will be further described with reference to FIG. 6. Without the IMS APN adjustment system 200 described herein, priority subscribers would be detrimentally impacted during initial attach procedures. Accordingly, embodiments provided herein add the IMS APN adjustment system 200 to interact with the illustrated components.

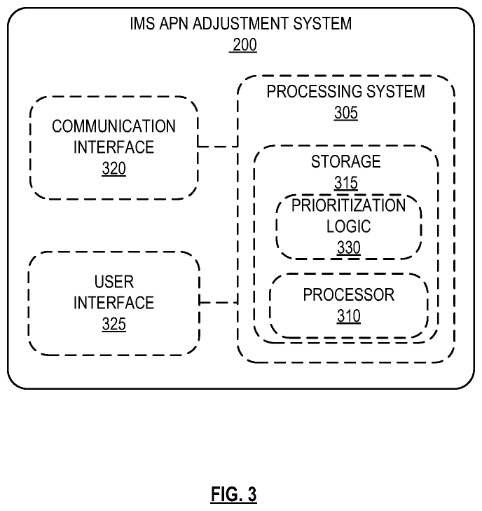

FIG. 3 depicts details of an IMS APN adjustment system 200 as a discrete component, which may be configured to perform the methods and operations disclosed herein to facilitate adjusting the IMS APN for a wireless device. In the disclosed embodiments, the IMS APN adjustment system 200 may be located within the MME of core network 102 or within the IMS 180 or may be integrated with various components in FIG. 2. Alternatively, or additionally, multiple IMS APN adjustment systems 200 may be disposed to accommodate wireless devices in different coverage areas 115, 116, 117.

The IMS APN adjustment system 200 ensures that roaming wireless devices can attach to an IMS APN when attaching to a visiting network 260. For example, if Central American MNO has a roaming agreement with a US MNO, a wireless device with a home network of Central American MNO can attach to an IMS APN for the US MNO for data services. To perform these functions, the IMS APN adjustment system 200 may include a processing system 305 including a storage area 315 and a processor 310. The storage device 315 may store logic 330. The logic 330 may include computer readable instructions to assist authenticating a roaming wireless device and changing the IMS APN for the roaming wireless device to a visited P-GW for the visiting network.

Storage device 315 may include a disk drive, a flash drive, a memory, or other storage device configured to store data and/or computer readable instructions or codes (e.g., software). The computer executable instructions or codes may be accessed and executed by processor 310 to perform various methods disclosed herein. Software stored in storage device 315 may include computer programs, firmware, or other form of machine-readable instructions, including an operating system, utilities, drivers, network interfaces, applications, or other type of software. For example, software stored in storage device 315 may include a module for performing various operations described herein. For example, instructions may be provided to look up wireless device user priorities, attach the priority to a response to an initial attach request, and transmit the response to ensure that priority is properly applied to each wireless user. Processor 310 may be a microprocessor and may include hardware circuitry and/or embedded codes configured to retrieve and execute software stored in storage device 315.

The IMS APN adjustment system may include a communication interface 320 and a user interface 325. Communication interface 320 may be configured to enable the processing system 305 to communicate with other components, nodes, or devices in the wireless network. For example, the IMS APN adjustment system 200 can provide instructions to the above-described components to ensure that priority is properly applied during initial attach procedures.

Communication interface 320 may include hardware components, such as network communication ports, devices, routers, wires, antenna, transceivers, etc. User interface 325 may be configured to allow a user to provide input to the IMS APN adjustment system 200 from other components, such as for example, the MME 210 shown in FIG. 2. User interface 325 may include hardware components, such as touch screens, buttons, displays, speakers, etc. The IMS APN adjustment system 200 may further include other components such as a power management unit, a control interface unit, etc.

The IMS APN adjustment system 200 thus may utilize the storage area 315 and the processor 310 to perform multiple operations. For example, the processor 310 may access stored instructions in the memory 315 to change and store the IMS APN for a roaming wireless device.

The methods, systems, devices, networks, access nodes, and equipment described herein may be implemented with, contain, or be executed by one or more computer systems and/or processing nodes. The methods described above may also be stored on a non-transitory computer readable medium. Many of the elements of communication system 100 may be, comprise, or include computers systems and/or processing nodes, including access nodes, controller nodes, and gateway nodes described herein.

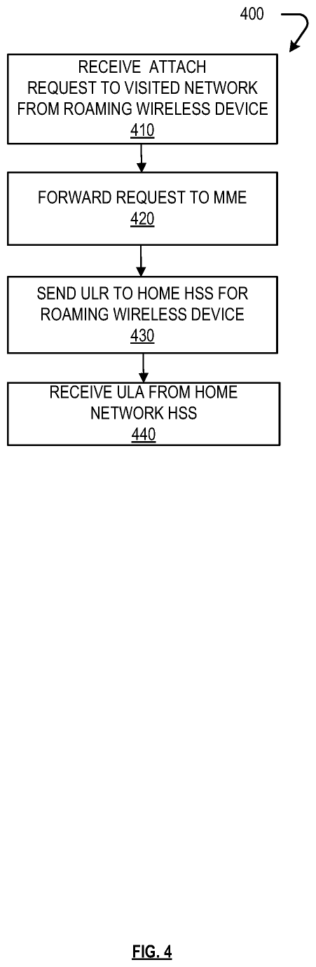

The disclosed methods for adjusting an IMS APN for a roaming wireless device are discussed further below. FIG. 4 illustrates an exemplary method 400 for processing an initial attach request in accordance with embodiments set forth herein. Method 400 may be performed by any suitable combination of processors discussed herein, for example, a processor contained in an access node, a processor contained in an MME 210 and the processor 310 included in the IMS APN adjustment system and/or other processors included in the components and functions shown in FIG. 2.

Method 400 begins in step 410, when an access node 110, 120, 130 receives an attach request from a wireless device 122, 124, 126, 128. The attach request may be embedded in a wireless device message. The message may also include a packet data network connectivity request message, a tracking area identifier (TAI) and an e-UTRAN cell global identifier (ECGI). Other information may also be included in the initial attach request.

In step 420, the access node 110, 120, 130 forwards the request to the MME 210 for authentication described above with respect to FIG. 2.

In step 430, the MME 210 sends a ULR for the wireless device to HSS 240. At the HSS 240, a ULA for the roaming wireless device is generated and sent to the MME 220. The ULA may include an IMS APN which is set to route back to a home P-GW of home network 250. The ULA may further include the mobile country codes and mobile network codes (MCCMNC) value for the home network 250 of wireless device 122, 124, 126, 128. The ULA is received by the MME 210 which utilizes it to perform various adjustments to the IMS APN for the roaming wireless device.

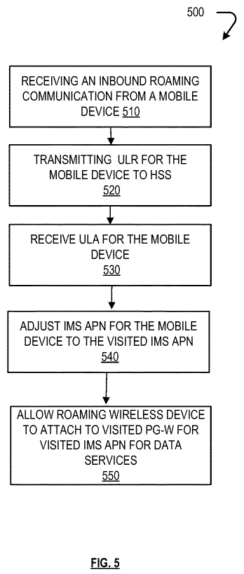

FIG. 5 illustrates further details of the method performed by the IMS APN adjustment system 200 in accordance with provided embodiments. Method 500 may be performed by any suitable processor discussed herein, for example, a processor 310 included in the IMS APN adjustment system 200 or a combination of the processor 310 with other processors, such as a processor of the MME 210. For discussion purposes, as an example, method 500 is described as being performed by the processor 310.

In step 510, the IMS APN adjustment system 200 receives an inbound roaming communication from a wireless device. The attach request for the inbound roaming communication is forwarded to the MME 240. The IMS APN adjustment system 200 transmits a ULR for the wireless device to HSS. The HSS generates a ULA for the ULR. The ULA may include an IMS APN which is set to route back to a home P-GW of home network 250. The ULA may further include the mobile country codes and mobile network codes (MCCMNC) value for the home network 250 of wireless device 122, 124, 126, 128.

At 530 is received IMS APN adjustment system 200 which utilizes it to perform various adjustments to the IMS APN for the roaming wireless device. At 540, the IMS APN adjustment systems 200 adjusts IMS APN for the roaming wireless device to the visited IMS APN. In embodiments set forth herein, MME 210 adjusts an IMS APN profile for roaming wireless device by changing the IMS APN for the roaming wireless device to the visited IMS APN (P-GW 204) of visited network 260 rather than the P-GW of home network 250. If the ULA does not include a home P-GW of home network 250 and/or MCCMNC value for the home network 250, the MME adjusts the IMS APN profile for the roaming wireless device by adding the visited IMS APN (P-GW 204) of visited network 260.

In some embodiments, methods 400 and 500 may include additional steps or operations. Furthermore, the methods may include steps shown in each of the other methods. As one of ordinary skill in the art would understand, the methods 400 and 500 may be integrated in any useful manner and the steps may be performed in any useful sequence.

The exemplary systems and methods described herein may be performed under the control of a processing system executing computer-readable codes embodied on a computer-readable recording medium or communication signals transmitted through a transitory medium. The computer-readable recording medium may be any data storage device that can store data readable by a processing system, and may include both volatile and nonvolatile media, removable and non-removable media, and media readable by a database, a computer, and various other network devices. Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid state storage devices. The computer-readable recording medium may also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A system configured for adjusting an IMS APN for a wireless device, the system comprising:
one or more hardware processors configured by machine-readable instructions to:
receive an inbound roaming communication from a wireless device to access a first IP multimedia core network subsystem (IMS) access point name (APN);
transmit an update-location-request (ULR) for the wireless device to home subscriber server;
receive an update-location-answer (ULA) for the wireless device; and
in response to receiving ULA for the wireless device, adjust an IMS APN for the wireless device to the first IMS APN for wireless device.

2. The system of claim 1, the ULA identifies a second IMS APN for the wireless device.

3. The system of claim 2, wherein adjusting an IMS APN may be modifying the second IMS APN to the first IMS APN for the wireless device.

4. The system of claim 2, wherein adjusting an IMS APN may be adding the first IMS APN for the wireless device.

5. The system of claim 1, wherein the response to the ULA does not identify an IMS APN for the wireless device.

6. The system of claim 5, wherein adjusting the IMS APN may be adding the first IMS APN for the wireless device.

7. The system of claim 2, wherein the first IMS APN is for a first mobile network operator.

8. A method for adjusting an IMS APN for a wireless device, the method comprising:
receiving an inbound roaming communication from a wireless device to access a first IP multimedia core network subsystem (IMS) access point name (APN);
transmitting an update-location-request (ULR) for the wireless device to home subscriber server;
receiving an update-location-answer (ULA) for the wireless device; and
in response to ULA for the wireless device, adjusting an IMS APN for the wireless device to the first IMS APN for wireless device.

9. The method of claim 8, the ULA identifies a second IMS APN for the wireless device.

10. The method of claim 9, wherein adjusting an IMS APN may be modifying the second IMS APN to the first IMS APN for the wireless device.

11. The method of claim 9, wherein adjusting an IMS APN may be adding the first IMS APN for the wireless device.

12. The method of claim 8, wherein the response to the ULA does not identify an IMS APN for the wireless device.

13. The method of claim 12, wherein adjusting the IMS APN may be adding the first IMS APN for the wireless device.

14. The method of claim 9, wherein the first IMS APN is for a first mobile network operator.

15. A non-transient computer-readable storage medium having instructions embodied thereon, the instructions being executable by one or more processors to perform a method for adjusting an IMS APN for a wireless device, the method comprising:
receiving an inbound roaming communication from a wireless device to access a first IP multimedia core network subsystem (IMS) access point name (APN);
transmitting an update-location-request (ULR) for the wireless device to home subscriber server;
receiving an update-location-answer (ULA) for the wireless device; and
in response to ULA for the wireless device, adjusting an IMS APN for the wireless device to the first IMS APN for wireless device.

16. The computer-readable storage medium of claim 15, the ULA identifies a second IMS APN for the wireless device.

17. The computer-readable storage medium of claim 16, wherein adjusting an IMS APN may be modifying the second IMS APN to the first IMS APN for the wireless device.

18. The computer-readable storage medium of claim 16, wherein adjusting an IMS APN may be adding the first IMS APN for the wireless device.

19. The computer-readable storage medium of claim 15, wherein the response to the ULA does not identify an IMS APN for the wireless device.

20. The computer-readable storage medium of claim 19, wherein adjusting the IMS APN may be adding the first IMS APN for the wireless device.
